(19) United States
(12) Patent Application Publication
(10) Pub. No.: US 2009/0157874 A1
(43) Pub. Date: Jun. 18, 2009

(54) MONITORING AND REPORTING SYSTEM AND METHOD OF OPERATING THE SAME

(76) Inventors: Steven D. Roemerman, Highland Village, TX (US); Richard H. Drohan, JR., Westborough, MA (US)

Correspondence Address: Chris Edgeworth;Stragent, 211 W. Tyler St., Longview, TX, 75601, US

(21) Appl. No.: 12/334,114

(22) Filed: Dec. 12, 2008

Related U.S. Application Data
(63) Continuation of application No. 11/039,158, filed on Jan. 20, 2005.
(60) Provisional application No. 60/537,625, filed on Jan. 20, 2004.

(51) Int. Cl. G06F 15/173

(52) U.S. Cl. 709/224

(57) ABSTRACT

A monitoring and reporting system for use with an embedded computer of a hosted system and method of operating the same. In one embodiment, the monitoring and reporting system includes a device driver configured to monitor a status of a user subsystem of the embedded computer and generate a status signal therefrom. The monitoring and reporting system also includes a modem configured to send a short message to an external device as a function of the status signal. The modem employs a low amount of overhead to send the short message expeditiously.

### RELATED APPLICATIONS

This application is a continuation of U.S. application Ser. No. 11/039,158, filed on Jan. 20, 2005, which claims the benefit of U.S. Provisional Application No. 60/537,625, filed on Jan. 20, 2004, both of which are incorporated herein by reference.

### TECHNICAL FIELD

The present invention relates generally to a communications systems and, more particularly, to monitoring and reporting system for use with a host system.

### BACKGROUND

A modem is a device that has traditionally allowed a computer system to transmit and receive data over a telephone line. Today, many modems can transmit voice and fax as well as data. Modems are currently implemented in a variety of ways. For example, a host based “controllerless” modem typically includes a codec on a peripheral board, but the modem controller code is executed by a host processor. A native signal processing modem typically implements a signal processing component on the host system itself to generate modem signals. Peripheral modems are implemented in a variety of ways, including both the use of a digital signal processor in conjunction with a modem microcontroller, and a strictly digital signal processor oriented approach.

New generations of host systems that encompass consumer appliances like set-top boxes, payphones, vending machines and other systems often require or prefer low-speed data modems. The data modems allow remote host systems to handle billing or other housekeeping functions, or permit “smart” vending machines to call for more supplies. Although typical microprocessor and digital signal processor based multimedia chips employed in set-top boxes and other systems are capable of implementing a low-speed modem, they usually do so at an undesirable complexity and expense.

Conventional modem architectures typically include multiple integrated circuits for handling modem processing and communication line termination. In particular, one or more digital signal processors are coupled to analog front-end circuitry, which in turn has been connected to line termination circuitry across a transformer isolation barrier. There have been attempts to integrate modem functionality and line-side isolation functionality. The modem accomplishes the aforementioned while also providing a modem interface that allows raw data, such as raw pulse code modulated data, or modem data to be selectively communicated through a serial interface.

Even in view of the advances in modem and communications system architecture, providing information from a remote host system to, preferably, a central server or the like can have a dramatic impact on the application for the such communication devices. The business implications associated with real time information about the host system are compelling. One of the limitations, however, is providing the information from the host system to the central server under less than ideal conditions.

As an example, suppose that a host system experiences a power down without notice to the central server. If central server cannot ascertain a status of the host system, several hours, if not days, can elapse leading to lost revenue due to the non-operational status of the host system. In conjunction therewith, it would make sense if the central server could be notified of the impending problem before it rises to a level of material concern. A reason that the notice does not occur is because, in many instances, the modems cannot transmit a message in time due to the overhead necessary to drive the message from the host system to the central server. The modems are simply to complex and require too much overhead by the host system to transmit the message.

What is needed in the art is a system including a modem and associated driver, preferably fault tolerant, for embedded computing systems of a host system that is very efficient in the transmission of short messages over telephony communication paths of indeterminate quality. The system should have the ability to resist system faults and failures to specific levels while providing protected data space for both the send buffer up to, for instance, 1500 bytes, and the receive buffer. The system should be able to collect and transmit status information even if the application fails. The system should also be able to recognize that the application has failed and auto-dial a predefined location for transmission of the contents of its send buffer. The system should address the aforementioned issues while, at the same time, overcoming the complexities of present solutions that cannot accommodate fast response, expeditious short messaging due to the high level of overhead associated therewith.

### SUMMARY OF THE INVENTION

These and other problems are generally solved or circumvented, and technical advantages are generally achieved, by preferred embodiments of the present invention which include a monitoring and reporting system for use with an embedded computer of a hosted system and method of operating the same. In one embodiment, the monitoring and reporting system includes a device driver configured to monitor a status of a user subsystem of the embedded computer and generate a status signal therefrom. The monitoring and reporting system also includes a modem configured to send a short message to an external device as a function of the status signal. The modem employs a low amount of overhead to send the short message expeditiously.

In a related aspect, the present invention provides a method of operating an embedded computer of a hosted system. The method includes monitoring a status of a user subsystem of the embedded computer and generating a status signal. The method also includes sending a short message to an external device as a function of the status signal with a modem. The modem employs a low amount of overhead to send the short message expeditiously.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1A and 1B illustrate block diagrams of embodiments of a host system containing an embedded computer in accordance with the principles of the present invention;

FIGS. 2A and 2B illustrate block diagrams of embodiments of monitoring and reporting systems constructed according to the principles of the present;

FIG. 3 illustrates a block diagram of an exemplary hard modem in accordance with the principles of the present invention;

FIG. 4 illustrates a chart showing a comparison of communications of various lengths when serviced by several different modem standards;

FIG. 5 illustrates a block diagram of another embodiment of a monitoring and reporting system constructed according to the principles of the present invention;

FIG. 6 illustrates a block diagram of another embodiment of a monitoring and reporting system constructed according to the principles of the present;

FIG. 7 illustrates a block diagram of another embodiment of a monitoring and reporting system constructed according to the principles of the present;

FIG. 8 illustrates a block diagram of another embodiment of a monitoring and reporting system constructed according. to the principles of the present invention; and

FIG. 9 illustrates a block diagram of another embodiment of a monitoring and reporting system constructed according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely, an electronic monitoring and reporting system in the environment of a host system whose status and condition it conveys via a fault tolerant modem architecture. The principles of the present invention, however, may also be applied to other types of electronic monitoring and reporting systems employable with the host system. The advantages associated with the monitoring and reporting system further exploit. the benefits associated with its fault tolerant architecture wherein the communication can be encrypted and thus rendered secure.

In accordance therewith, the present invention provides a system and method for providing monitoring and reporting services of for host system via an embedded approach contained within and/or attached to an embedded computer (or computer system) included as part of the host system.

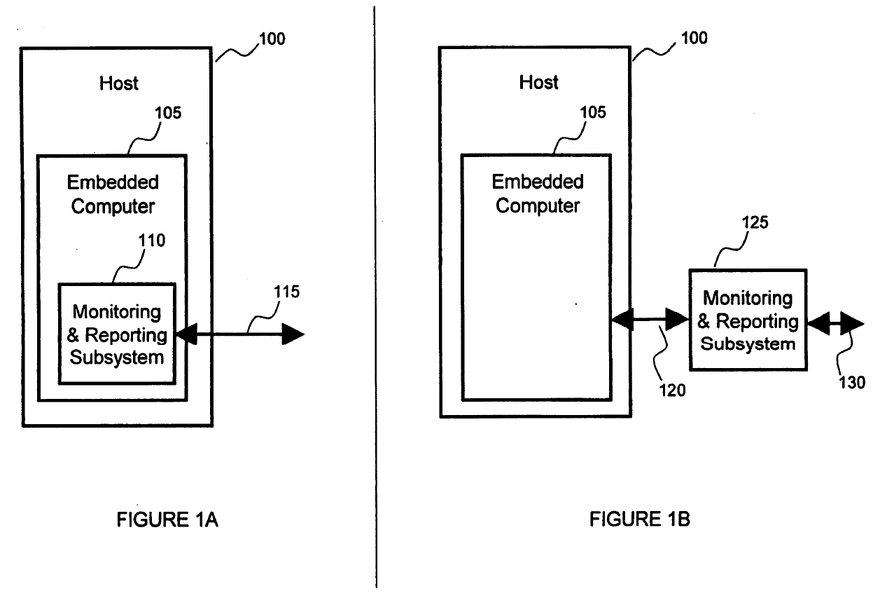

Referring initially to FIGS. 1A and 1B, illustrated are block diagrams of embodiments of a host system 100 containing an embedded computer 105 in accordance with the principles of the present invention. The host system 100 of FIG. 1A illustrates a monitoring and reporting system 110 within and integral to the embedded computer 105 and communicating externally and remotely via a telephony communications path 115. FIG. 1B illustrates an alternate embodiment of the host system 100 wherein a monitoring and reporting system 125 is external to the host system, but connected to the embedded computer 105 via a communications path 120 which, as an example, can be a serial connection. It should be understood, however, the other communication paths such as a universal serial bus, a parallel bus, a Personal Computer Memory Card International Association (PCMCIA), and an alternating current link may also be employed to advantage. The monitoring and reporting system 125 communicates externally and remotely via a telephony communications path 130.

The host system 100 may include medical equipment such as heart monitors or drug dispensing equipment whose status, in real time, is critical and whose need for maintenance reporting may also be critical. Other examples for the host system 100 include vending machines whose current status on inventory, and proper operation, when remotely reported, can substantially reduce maintenance costs while, at the same time increasing machine “up-time” and customer satisfaction. Yet another example includes industrial automation equipment generally operating untended. Here, any variation from normal operation can be quickly reported and corrective action taken. Additionally, the host system 100 may be compatible with WiFi and broadband networks. These examples are only meant to be representative of the applications to which this invention may be employed with systems using embedded computing and are not meant to be comprehensive. Those skilled in the art will readily see other examples which are comprehended by this invention.

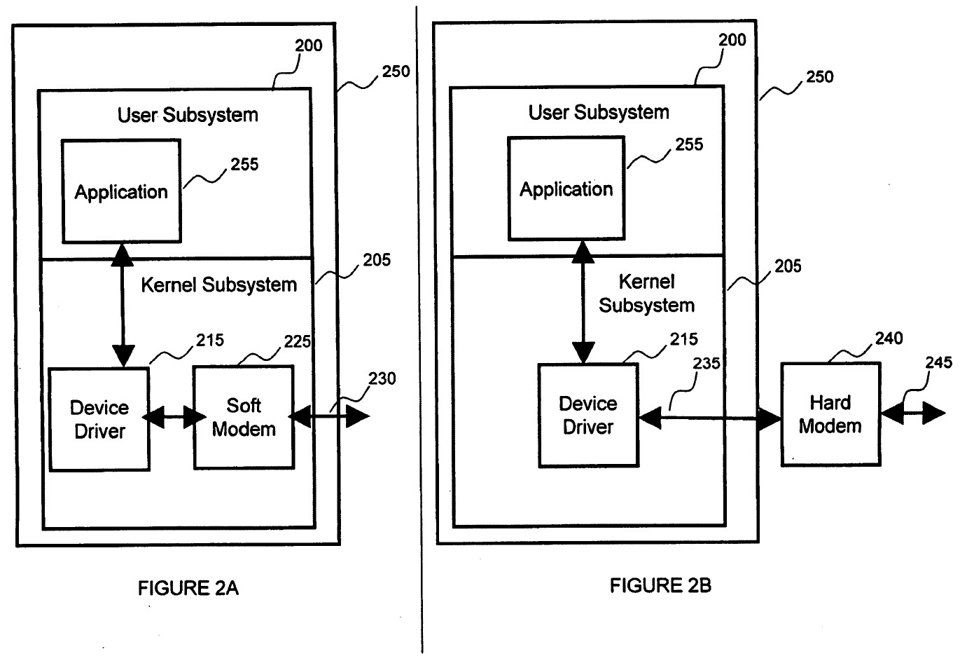

Turning now to FIGS. 2A and 2B, illustrated are block diagrams of embodiments of monitoring and reporting systems constructed according to the principles of the present invention. The present embodiment of the monitoring and reporting system introduces a software centric version thereof. It is considered a software version because a single kernel exists and it is in this environment that a modem driver is installed. The monitoring and reporting system embodied in an embedded computer 250. The embedded computer 250 includes a user subsystem 200 with applications 255 such as control and operating applications for the host system. The embedded computer 250 also includes a kernel subsystem 205. An example of the kernel subsystem 205 is an operating system such as a Windows embedded system (e.g., Windows NT, Windows CE and Windows XPE) and other operating systems (e.g., VxWorks, RTLinux, LynxOS, pSOS, and many others). These examples are not meant to be exhaustive, but are merely illustrative of the many operating systems for which this invention applies and which are comprehended by it.

With respect to FIG. 2A, a soft modem architecture is illustrated and hereinafter described. A soft modem is a construct that embodies a logical modem function in software. The soft modem relies on the computing power of the embedded computer 250 to perform most functions except for input/output driver functions and interfaces with a telephony systems. Inasmuch as the aforementioned functions typically consist of generating voltages and currents incapable of and/or damaging to standard digital circuitry, the input/output driver functions and interfaces are typically embodied in hardware elements, even for soft modems. For an example of software modem, see U.S. Pat. No. 5,925,114 entitled “Modem Implemented in Software for Operation on a General Purpose Computer Having Operating System with Different Execution Priority Levels,” to Hoang, issued Jul. 20, 1999, which is incorporated by reference.

A device driver 215 of the monitoring and reporting system accepts messages and commands from the applications 255 to transmit a message via a soft modem 225. The device driver 215 and the soft modem 225 reside within the kernel subsystem 205 and communicate via a memory map, direct memory access, or other similar internal computer interface or subsystem. The soft modem 225 then outputs data telephonically via an output 230. The monitoring and reporting system may also support two way communication via an input/output device to an external device of system.

Turning now to FIG. 2B, illustrated is an alternate embodiment of a monitoring and reporting system wherein the device driver 215 is communicating via an external interface 235 (e.g., a serial port) with a hardware (also referred to as a “hard”) modem 240 external to the core embedded processing. The hard modem then outputs data telephonically via an output 245.

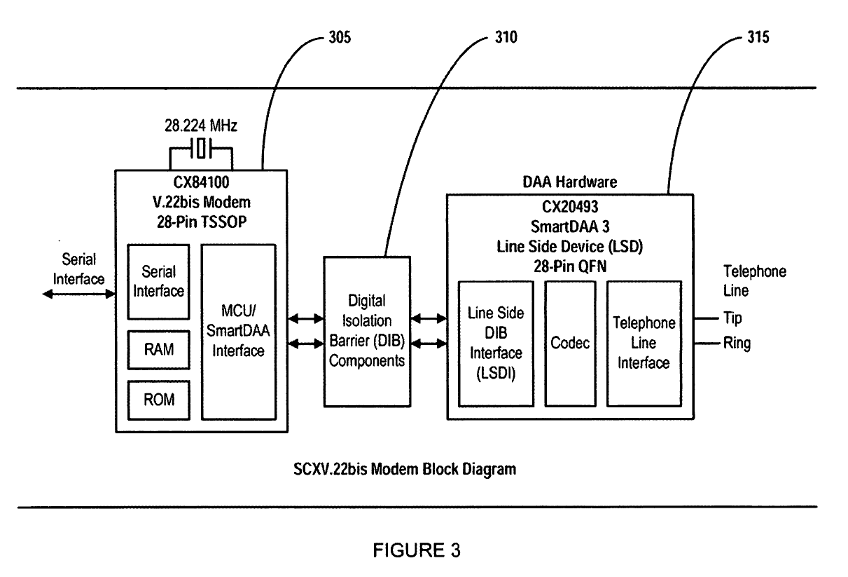

Turning now to FIG. 3, illustrated is a block diagram of an exemplary hard modem in accordance with the principles of the present invention. The modem 305, shown here as an integrated circuit, performs the modulation functions and message constructing functions. While the modem 305 connects to a computer, embedded or otherwise, via a serial interface in this embodiment, other interfaces, as discussed above, are clearly possible. The modem 305 is connected to a digital isolation barrier (DIB) 310, which protects the digital circuitry from the large telephonic signals and noise spikes common on those lines. Connected on the line side of the digital isolation barrier is a DAA hardware 315. which performs a signal transformation to the appropriate voltages and drive levels necessary to convey the desired communication over a telephony communications path. When a soft modem is employed, the embedded computer assumes the function element of the modem 305. In the present embodiment, the hard modem is compatible with standardized communication protocols such as an International Telecommunications Union (ITU) V.22, and ITU V.22bis. Of course, other modem types compatible with different standards are well within the broad scope of the present invention.

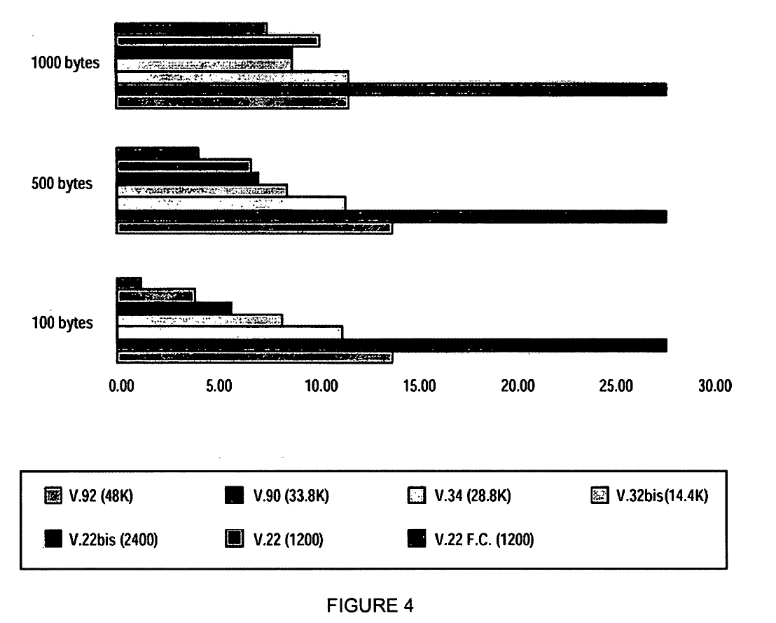

Turning now to FIG. 4, illustrated is a chart showing a comparison of communications of various lengths when serviced by several different modem standards. It is immediately apparent that more modern standards, for example ITU V.92, while efficient in transmitting large messages at high data rates are very inefficient when it comes to transmitting short messages. Here, it is demonstrated that the ITU V.90 and ITU V.92 modems use about the same amount of time, each independent of whether the message is 100, 500, or 1000 bytes long. This is due to the large amount of overhead associated with these standards.

In contrast, the ITU V.22 modem is able to transmit small messages much faster than more advanced standards, even though it is only transmitting at 1200 baud. Additionally, the total message time is substantially less when both sides comply with the ITU V.22 standard. Therefore, for short messages of less than 1500 bytes, the ITU V.22 modem is efficient when considering message length and is preferable when employed with the monitoring and reporting system of the present invention. Also, a very modest 1200 baud transmission speed means that successful transmissions can occur even over very marginal telephony communication paths.

Also, once a connection has been “trained,” the proper connect time can be realized each time the connection is made between the host system employing the modem and the data collection point. Additionally, if both ends of the communication support the same standard such as ITU V.22, then the connect and retrain time should be shorter, which assists in the expeditious nature of the communication therebetween. In short, the modem should be configured to send a short message expeditiously due to a low amount of overhead associated therewith, even if the overall transmission speed is modest. Stated another way, a characteristic of a modem particularly suited for the present invention is one wherein the number of transmitted bits varies approximately linearly as the size of the message due to the low amount of overhead associated therewith.

As an example, the V.22 Fast Connect modem provides additional functionality allowing to discriminate and speed up ITU V.22 connections for consecutive half- or full-duplex data exchange at 9600, 7200 and 1200 bps. The V.22 Fast Connect modem is tuned to operate on the worst case of Bell3002 channel with low signal-to-noise (SNR) and other channel distortions. The V.22 Fast Connect interfaces with high-level data link control (HDLC)/synchronous data link control (SDLC) protocols and has transparent HDLC/SDLC framing, frame check sequence generation and checking. The V.22 Fast Connect includes an integrated state machine to control standard and recovery procedures. The software is reentrant, supports multithreading and dynamic memory allocation. At the same time allows direct (non-eXpressDSP) interface to enable static memory allocation. For a better understanding of a V.22 Fast Connect modem, see “POS Fast Connect Operation,” Application Note AN_{—}2901_{—}011, published by TDK Semiconductor Corporation, July 2004, which is incorporated by reference.

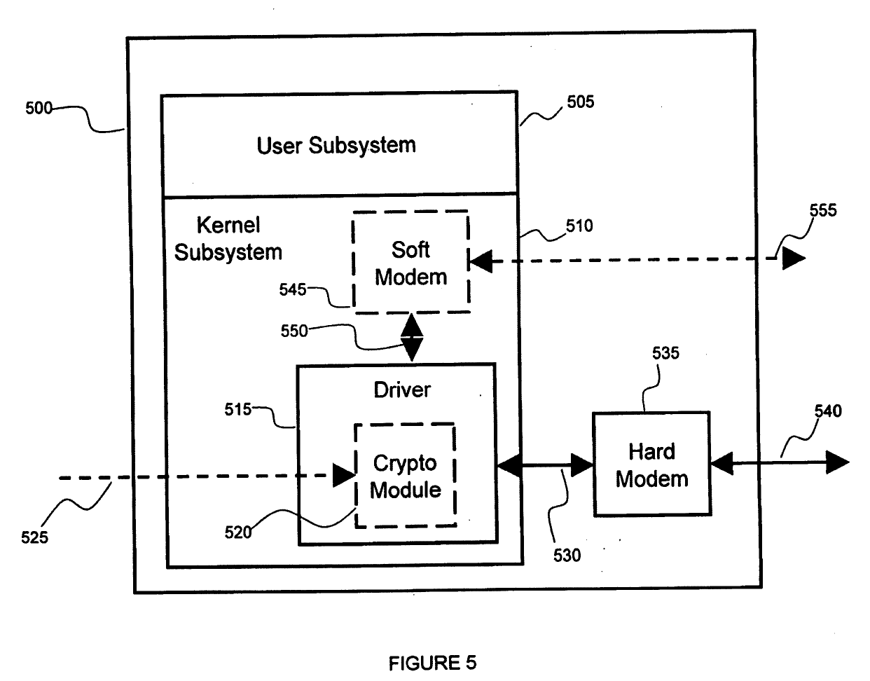

Turning now to FIG. 5, illustrated is. a block diagram of an embodiment of a monitoring and reporting system constructed according to the principles of the present invention. The monitoring and reporting system includes a fault tolerant driver with a cryptographic module therein. By varying degrees, a fault tolerant device is adapted to operate, even at some level, when the systems thereabout are not operating or are powering down. An embedded computer 500 including a user subsystem 505 and a kernel subsystem 510 embodies the monitoring and reporting system of the present invention. The kernel subsystem 510 contains a driver (e.g., a fault tolerant driver) 515 with a cryptographic module 520. An example of a cryptographic module 520 is a module certified to the FIPS-140-2 standard. FIPS PUB 140-2 refers to the Federal Information Processing Standards Publication entitled “Security Requirements for Cryptographic Modules,” dated Dec. 3, 2002 and incorporated herein by reference.

A module of this type will enable fault tolerant secure communications to the fault tolerant capabilities of the monitoring and reporting system. For instance, TACHYON-Crypt provides a comprehensive suite of industry-standard cryptographic algorithms including AES, 3DES, SHA-1, and public-key encryption algorithms like RSA and Diffie-Hellman. Its design enables the embedded developer to customize a source-level cryptographic module to suit a specific application, including tuning performance verses memory tradeoffs, and various security features. Additionally, ITU V.44 stacks are available for enabling encryption, data compression and correction. This enables secure modem communications between the embedded computer and the enterprise. This is a particularly applicable in medical applications subject to the Health Insurance Portability and Accountability Act of 1996, Public Law 104-191 requirements.

Continuing on, a signal path 525 provides a cryptographic key path to the cryptographic module 520. The driver 515 either controls a software modem 545 via an internal interface 550 or a hard modem 535 via an external interface 530. Additionally, the driver 515 monitors a status of the user subsystem 505 and generates a status signal therefrom, which is provided to the software modem 545 via the internal interface 550 or the hard modem 535 via the external interface 530. A pair of telephony communication paths 540, 555 provides an interface to external devices. The software modem 545 or the hard modem 535 sends a short message to the external devices via the telephony communication paths 555, 540 in response to the status signal.

The driver 515 continues to operate provided that the operating system or kernel subsystem 510 in which it resides is operational. The driver 515 should be configured to resist minor faults and failures and provide protected data space for both the send buffer (e.g., up to 1500 bytes) and receive buffer thereof. The driver 515 collects information about the status of a host system, even if the applications fail. The driver 515 recognizes that the applications have failed and causes the modem to auto-dial a predefined location for transmission of the contents of its send buffer. The resources utilized by the driver 515 including memory and interrupts are maintained by a real-time operating system (RTOS) or in a non-real time operating system such as Windows, by a RING 0 device driver. As a result, the monitoring and reporting system, which encompasses the systems within the embedded computer, can monitor, log and notify a location distant from the host system that an error has occurred including key parameters thereabout. Additionally, the monitoring and reporting system supports a hosted signal processing modem. The same or analogous principles apply to other embodiment of the monitoring and reporting system as disclosed herein or developed in accordance herewith.

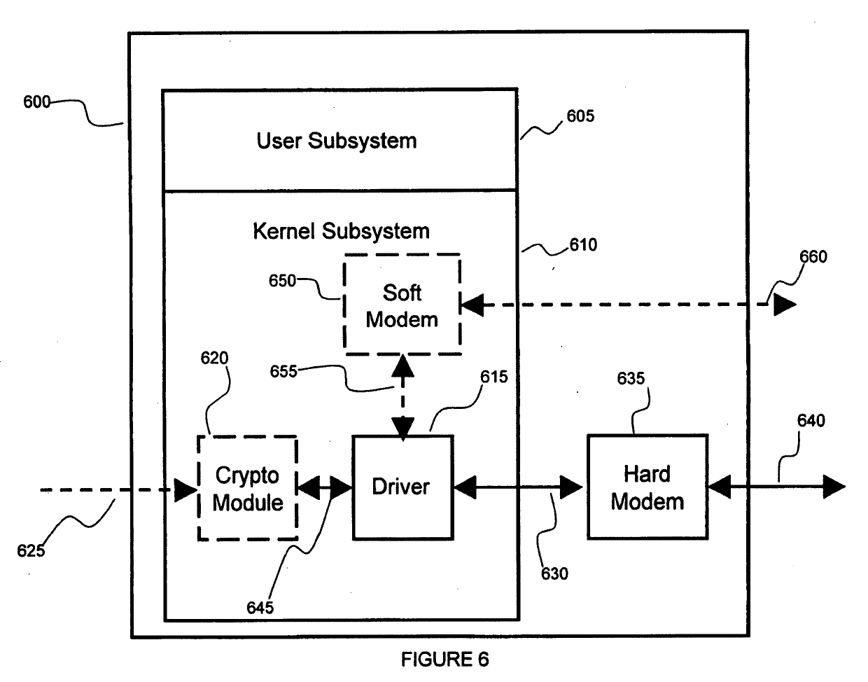

Turning now to FIG. 6, illustrated is a block diagram of another embodiment of a monitoring and reporting system constructed according to the principles of the present invention. A fault tolerant driver is contained within a kernel subsystem and where an optional cryptographic capability is included external to the driver. An embedded computer 600 containing a user subsystem 605 and a kernel subsystem 610 embodies the monitoring and reporting system of the present invention. The kernel subsystem 610 contains a driver (e.g., a fault tolerant driver) 615 and a cryptographic module 620 having properties and capabilities analogous to the cryptographic module 520 illustrated and described with respect to FIG. 5.

Continuing on, a signal path 625 provides a cryptographic key path to the cryptographic module 620 and a signal path 645 is present as an interface to the driver 615. The driver 615 can either control a software modem 650 via an internal interface 655 or a hard modem 635 via an external interface 630. Additionally, the driver 615 monitors a status of the user subsystem 605 and generates a status signal therefrom, which is provided to the software modem 650 via the internal interface 655 or the hard modem 635 via the external interface 630. A pair of telephony communication paths 640, 660 provides an interface to external devices. The software modem 650 or the hard modem 635 send a short message to the external devices via the telephony communication paths 660, 640 in response to the status signal.

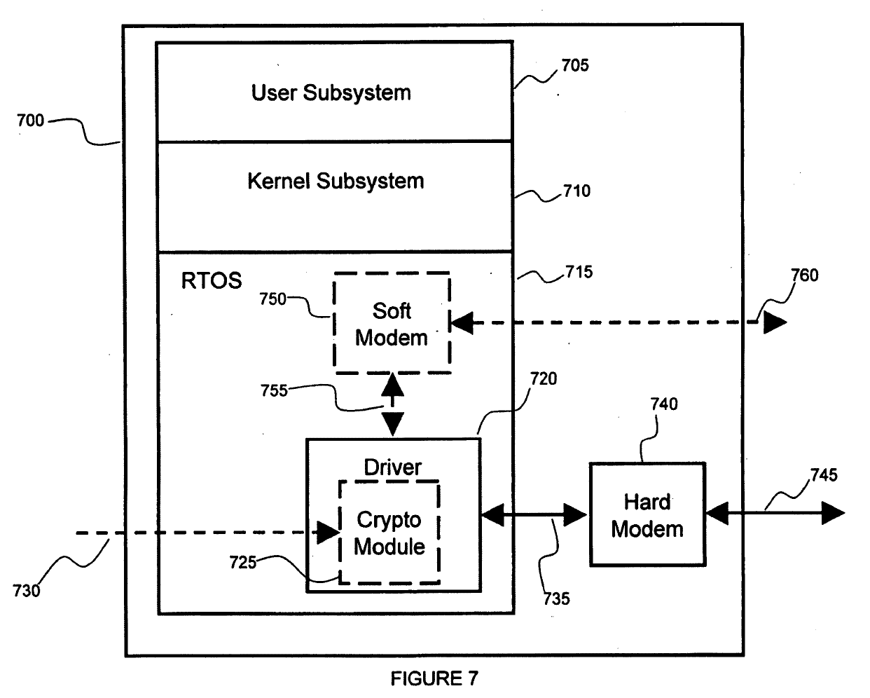

Turning now to FIG. 7, illustrated is a block diagram of another embodiment of a monitoring and reporting system constructed according to the principles of the present invention. A fault tolerant driver is contained within a dedicated real time operating system and where an optional cryptographic module is included within the fault tolerant driver. Illustrative examples of real time operating systems include, but not limited to, Windows CE, LynxOS, pSOS, RTLinux and VxWorks. An embedded computer 700 containing a user subsystem 705, a kernel subsystem 710 which is typically a non real time operating system and an RTOS 715 embodies the monitoring and reporting system of the present invention. The RTOS 715 contains a driver (e.g., a fault tolerant driver) 720 and may contain a cryptographic module 725. The cryptographic module 725 has properties and capabilities analogous to the cryptographic module 520 illustrated and described with respect to FIG. 5.

Continuing on, a signal path 730 provides a cryptographic key path to the cryptographic module 725. The driver 720 can either control a software modem 750 via an internal interface 755 or a hard modem 740 via an external interface 735. Additionally, the driver 720 monitors a status of the user subsystem 705 and generates a status signal therefrom, which is provided to the software modem 750 via the internal interface 755 or the hard modem 740 via the external interface 735. The software modem 750 or the hard modem 740 sends a short message to the external devices via telephony communication paths 760, 745 in response to the status signal.

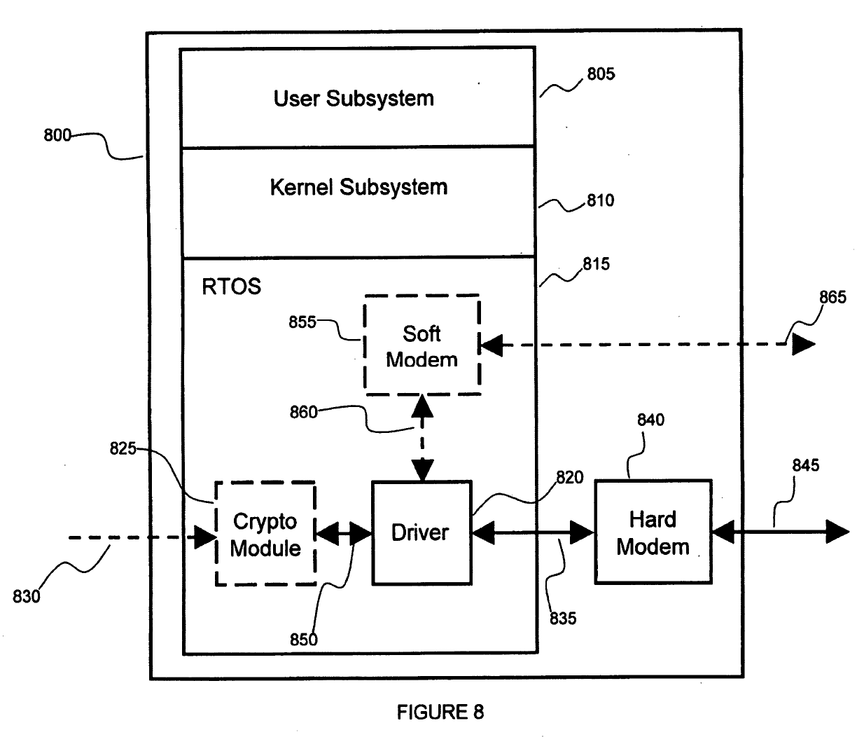

Turning now to FIG. 8, illustrated is a block diagram of another embodiment of a monitoring and reporting system constructed according to the principles of the present invention. A fault tolerant driver is contained within a dedicated real time operating system and where an optional cryptographic module is included within the RTOS but separate from the fault tolerant driver. An embedded computer 800 containing a user subsystem 805, a kernel subsystem 810 which is typically a non real time operating system and an RTOS 815 embodies the monitoring and reporting system of the present invention. The RTOS 815 contains a driver (e.g., a fault tolerant driver) 820 and may contain an optional and separate cryptographic module 825. The cryptographic module 825 has properties and capabilities analogous to the cryptographic module 520 illustrated and described with respect to FIG. 5.

Continuing on, a signal path 830 provides a cryptographic key path to the cryptographic module 825 and a signal path 850 is present as an interface to the driver 820. The driver can either control a software modem 855 via an internal interface 860 or a hard modem 840 via an external interface 835. Additionally, the driver 820 monitors a status of the user subsystem 805 and generates a status signal therefrom, which is provided to the software modem 855 via the internal interface 860 or the hard modem 840 via the external interface 835. The software modem 855 or the hard modem 840 sends a short message to the external devices via telephony communication paths 865, 845 in response to the status signal.

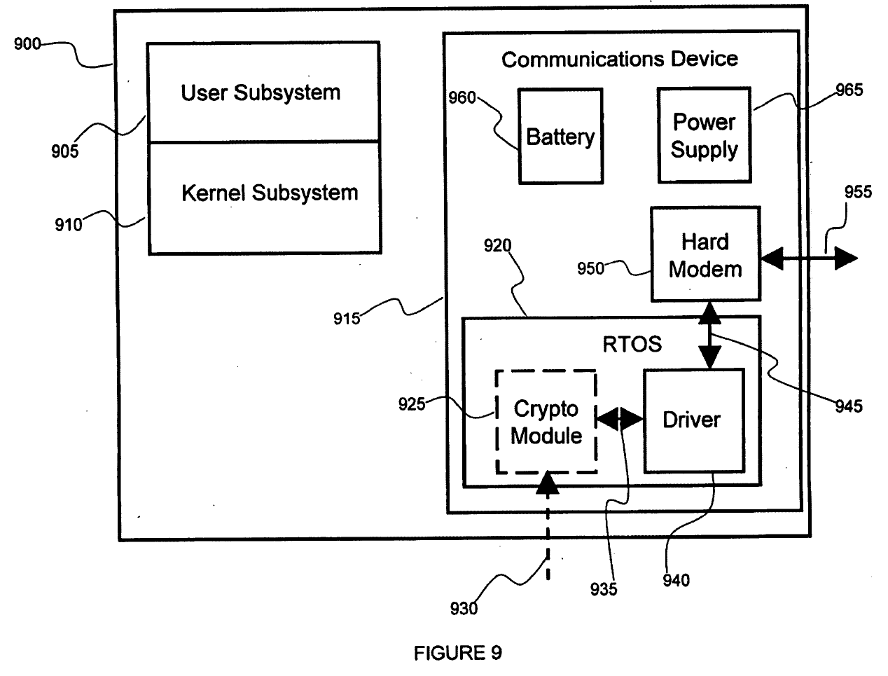

Turning now to FIG. 9, illustrated is a block diagram of another embodiment of a monitoring and reporting system constructed according to the principles of the present invention. Whereas in the embodiments of FIGS. 5-8, a single embedded computer with a single microprocessor was comprehended, here a communication device shall contain its own RTOS and its own embedded computer function. An embedded computer 900 includes a user subsystem 905, a kernel subsystem 910, and a separate communications device 915. The monitoring and reporting system is contained within communication device 915. The communication device 915 includes a separate RTOS 920, a driver (e.g., a fault tolerant driver) 940, and an optional cryptographic module 925 having properties and capabilities analogous to the cryptographic module 520 illustrated and described with respect to FIG. 5.

Continuing on, a signal path 930 provides a cryptographic key path to the cryptographic module 925 and a signal path 935 is present as an interface to the driver 940. The driver controls a hard modem 950 via an interface 945. Additionally, the driver 940 monitors a status of the user subsystem 905 and generates a status signal therefrom, which is provided to the hard modem 950 via the interface 945. The hard modem 950 sends a short message to the external devices via telephony communication paths 955 in response to the status signal. The communications device 915 also includes a battery 960 and a separate power supply 965. The battery 960 is capable of providing full power to the communications device 915 even should the power of the embedded computer 900 fail.

Although the aforementioned embodiment illustrates a hard modem, those skilled in the art understand that a soft modem or other modem like devices may be employed with the monitoring and reporting system and still fall within the broad scope of the present invention. While the V.22 and V.22 Fast Connect modems and cryptographic modules compliant with FIPS-140-2 have been featured in the illustrative embodiments above, this invention comprehends other modem standards and other cryptographic modules which are to be included as part of this invention.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the monitoring and reporting system may be applied to a number of host systems and embedded computers in performing the requisite tasks and remain within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A monitoring and reporting system for use with an embedded computer of a hosted system, comprising:
a device driver configured to monitor a status of a user subsystem of said embedded computer and generate a status signal therefrom; and
a modem configured to send a short message to an external device as a function of said status signal, said modem employing a low amount of overhead to send said short message expeditiously.

2. The monitoring and reporting system as recited in claim 1 wherein said device driver monitors a status of an application of said user subsystem.

3. The monitoring and reporting system as recited in claim 1 wherein said device driver is located within a kernel subsystem of said embedded computer.

4. The monitoring and reporting system as recited in claim 1 wherein said modem is selected from the group consisting of:
a software modem, and
a hardware modem.

5. The monitoring and reporting system as recited in claim 1 wherein said modem is a V.22 Fast Connect modem.

6. The monitoring and reporting system as recited in claim 1 further comprising a cryptography module configured to perform encryption on said short message.

7. The monitoring and reporting system as recited in claim 1 wherein said system is embodied in a real time operating system.

8. The monitoring and reporting system as recited in claim 1 wherein said system is embodied in a separate communications device within said embedded computer.

9. The monitoring and reporting system as recited in claim 8 wherein said communications device includes a real time operating system, a power supply and a battery.

10. The monitoring and reporting system as recited in claim 1 wherein said short message is about 1500 bytes.

11. A method of operating an embedded computer of a hosted system, comprising:
monitoring a status of a user subsystem of said embedded computer;
generating a status signal; and
sending a short message to an external device as a function of said status signal with a modem, said modem employing a low amount of overhead to send said short message expeditiously.

12. The method as recited in claim 11 wherein said monitoring includes monitoring a status of an application of said user subsystem.

13. The method as recited in claim 11 wherein said monitoring is performed by a device driver located within a kernel subsystem of said embedded computer.

14. The method as recited in claim 11 wherein said modem is selected from the group consisting of:
a software modem, and
a hardware modem.

15. The method as recited in claim 11 wherein said modem is a V.22 Fast Connect modem.

16. The method as recited in claim 11 further comprising encrypting said short message.

17. The method as recited in claim 11 wherein said method is performed by a system embodied in a real time operating system.

18. The method as recited in claim 11 wherein said method is performed by a system embodied in a separate communications device within said embedded computer.

19. The method as recited in claim 18 wherein said communications device includes a real time operating system, a power supply and a battery.

20. The method as recited in claim 11 wherein said short message is about 1500 bytes.
